(19) United States
(12) Patent Application Publication
(10) Pub. No.: US 2013/0212807 A1
(43) Pub. Date: Aug. 22, 2013

(54) BED CHAIR

(71) Applicants: Wayne Smeaton Manson, Auckland (NZ); Ryan Graham, Auckland (NZ)

(72) Inventors: Wayne Smeaton Manson, Auckland (NZ); Ryan Graham, Auckland (NZ)

(73) Assignee: MULTIFIT HOSPITAL SUPPLIES LIMITED, Auckland (NZ)

(21) Appl. No.: 13/696,226

(22) PCT Filed: May 5, 2011
(86) PCT No.: PCT/NZ2011/000068

§ 371 Date: Jan. 22, 2013

(30) Foreign Application Priority Data
May 5, 2010 (JP) 585121
Sep. 20, 2010 (JP) 588071

(51) Int. Cl. A61G 7/015

(52) U.S. Cl. CPC A61G 7/015
USPC 5/618

(57) ABSTRACT

A bed chair apparatus has a user support surface which includes a back section (I), a seat section (14), a lower leg section (15) and a foot section (16) that are configured to articulate relative to each other. The support surface is configurable in a bed configuration in which the support surface is substantially flat and in a chair configuration in which the foot section (16) is disposed beneath the seat section (14). Some embodiments of the apparatus require only a single actuator (46). A pivoting platform apparatus is also disclosed.

### FIELD OF THE INVENTION

This invention relates to a piece of resting furniture and has particular relevance to a bed which is convertible to a chair or chair-like configuration.

### BACKGROUND

Many people, particularly disabled people, find it difficult getting in and out of bed. The reasons for this are many but include:
a) general muscle weakness because of age, sickness, disease, low mental ability or balance; and
b) inability or difficulty of movement because of surgery, hip replacement or back injury.

Caregivers for this type of patient also have problems with caring for the patient. Among their concerns are manual handling injury caused by helping the patient in and out of bed and back injuries from having to stoop over a low bed when tending to a patient. Surface shear on the patient skin as the patient is being transferred on and off the bed, or as the mattress profiles under the body of the patient, can also be an issue.

Existing solutions include:

1. Powered Leg Lifters

These work with some people but many people cannot use them because:
a) they lack the required muscle strength to balance on the bed as their feet are being raised;
b) they cannot use the handset controller that is typically required for use of the product;
c) they do not have the ability to move their feet off the leg lifter foot rest and onto the bed; and
d) they do not like the appearance of the leg lifter beside their bed.

2. Chair Beds

These are basically recliner chairs with a mattress topper pad for extra comfort. Some chair beds have additional width to simulate a bed and some are made with customized seat depth and height to suit the user's posture and stature.

Chair beds work with some people but many people cannot use them because:
a) the mattress platform does not lay completely flat and therefore they are not able to roll onto their sides for comfort while sleeping;
b) the mattress platform is always too short. This is because the seat height determines the length of the leg rest. When the leg rest raises to the horizontal position their feet are left hanging over the end of the leg rest and are therefore unsupported;
c) the chair bed looks like a chair and not a bed and therefore can be rejected as a bedroom item; and
d) the chair bed is a fixed height and is therefore at a very low position for care giving tasks.

3. Bed chairs

These typically provide a full bed which is convertible into a chair-like form. The disadvantages include:
a) poor ergonomic design which make them very uncomfortable to sit in and use;
b) the motors are slow and work independently which means users have to know which button to push and for how long in order to get the sit to lie action working properly;
c) they are very heavy to transport; and
d) some try to solve the problem of the feet hanging over the end of the mattress by providing a foot plate which rises with the leg rest and prevents a user's feet coming off the end of the mattress, but the result is that the patient's body is either pushed up into the mattress or their legs become bent. When in the lie flat position their feet also end up being pushed hard against the foot rest which can be cold and uncomfortable.

4. Inflatable Chairs:
a) these are designed to hoist a person into and therefore do not support independent transfer on and off the bed;
b) they do not lie completely flat; and
c) feet are typically left unsupported when in the horizontal position.

The reference to any prior art in the specification is not, and should not be taken as, an acknowledgement or any form of suggestion that the prior art forms part of the common general knowledge in any country.

### OBJECT

It is an object of the present invention to provide a resting apparatus such as a bed or bed chair which will overcome one or more of the foregoing disadvantages. Alternatively, it is an object of the present invention to provide a leg lifter which will overcome one or more of the disadvantages with existing constructions. Alternatively, it is an object of the present invention to provide a pivoting platform apparatus which will overcome one or more of the disadvantages with existing constructions. In a further alternative, it is an object of the present invention to at least provide the public with a useful choice.

### SUMMARY

According to one aspect of the present invention there is provided a bed chair apparatus including a user support surface which includes a back section, a seat section, a lower leg section and a foot section that are configured to articulate relative to each other, whereby the user support surface is configurable in a bed configuration in which the support surface is substantially flat and in a chair configuration in which the foot section is disposed beneath the seat section.

Preferably the bed chair apparatus comprises a base frame, a middle frame and an adjustable carriage.

Preferably the adjustable carriage is movable longitudinally relative to the middle frame.

Preferably the bed chair apparatus is adapted to be moved between the bed configuration and the chair configuration by a single actuation means.

Preferably the actuation means moves the adjustable carriage.

Preferably movement of the adjustable carriage causes movement of the back section and foot section.

Preferably the bed chair apparatus comprises a foot section link member between the adjustable carriage and the foot section.

Preferably the bed chair apparatus comprises a back section link member between the adjustable carriage and the back section.

Preferably the bed chair apparatus comprises a rocker arm rotatably connected to the middle frame and a rocker arm link member connecting the back section and the rocker arm.

Preferably movement of the adjustable carriage along a portion of its travel causes rotation of the rocker arm and thereby movement of the back section.

Preferably the adjustable carriage is provided with guide means and the rocker arm is provided with follower means which bear against the guide means.

Preferably an actuation means moves said adjustable carriage relative to said middle frame, said adjustable carriage provided with a further actuation means which is connected to the foot section by a foot section link member.

Preferably the adjustable carriage is provided with a leg portion and a foot portion, and wherein the foot portion is located substantially beneath the foot section when the bed chair is in the bed configuration.

Preferably the support surface comprises a mattress which is provided on a frame, the frame having pivotal connections between adjacent sections of the support surface to enable the sections to articulate relative to each other.

Preferably the pivotal connections between sections of the support surface are closer to an upper surface of the mattress than to a lower surface of the mattress.

According to a second aspect of the present invention there is provided a bed chair apparatus including a user support surface comprising a plurality of sections that are configured to articulate relative to each other such that the user support surface is configurable in a bed configuration in which the support surface is substantially flat and in a chair configuration, the support surface comprising a mattress which is provided on a frame, the frame having pivotal connections between adjacent sections of the support surface to enable the sections to articulate relative to each other, wherein the pivotal connections between sections of the support surface are closer to an upper surface of the mattress than to a lower surface of the mattress.

According to a third aspect of the present invention there is provided a leg lifter having a frame, an arm pivotally connected to the frame at one end, a foot support surface located on the arm, the foot support surface being movable along the arm, a control rod pivotally connected between the foot support surface and the frame such that as the foot support surface is moved along the arm, the arm is raised relative to the frame, and a flexible connector provided between the other end of the arm and the other end of the frame.

Preferably the flexible connector provides a chain which allows the arm to remain stable in one plane yet flex in the other plane.

Preferably the control rod is pivotally connected to the frame at a point on the frame above the lowest extent of the lifting surface.

According to a fourth aspect of the present invention there is provided a pivoting platform apparatus including a base frame, a platform pivotally mounted to the base frame and rotatable about a substantially vertical axis of rotation, and a support member connected to the platform, the support member provided with hand rail means.

Preferably the support member is substantially adjacent said substantially vertical axis of rotation.

Preferably the apparatus is provided with means for causing said platform to rotate about the axis of rotation.

Preferably the support member is pivotally connected to said platform and biased towards a substantially vertical orientation.

Preferably the support member comprises an upper support member which is pivotally connected to a lower support member.

Preferably an upper support member actuator is provided between said lower support member and said upper support member.

Preferably a lower support member actuator is provided between said platform and said lower support member.

According to a further aspect of the present invention there is provided a bed chair of the first or second aspect provided with a leg lifter of the third aspect and/or a pivoting platform apparatus of the fourth aspect.

According to a further aspect of the present invention there is provided a bed chair substantially as herein described with reference to any one or more of the accompanying examples and/or figures.

In another aspect the invention provides any new feature or new combination of features described herein.

Further aspects of the invention, which should be considered in all its novel aspects, will become apparent from the following description given by way of example of possible embodiments of the invention.

### DRAWING DESCRIPTION

Embodiments of the invention will be described below with reference to the accompanying drawings, in which:

FIG. 1: is a side elevation of a first embodiment of the bed chair according to the invention;

FIGS. 2 to 7: are side elevations of the embodiment of FIG. 1 showing various folding configurations of the bed chair.

FIGS. 8 to 11: show the embodiment of the preceding Figures in a lie flat position illustrating various height adjustments.

FIGS. 12 to 15: are a plan view of an embodiment of the preceding Figures, a rear view, a side elevation and front view respectively.

FIG. 16: shows a side elevation of the embodiment of FIG. 1 with the middle frame highlighted.

FIG. 17: shows a plan view of a middle frame of the embodiment of FIG. 1.

FIG. 18: is a side view of the embodiment of FIG. 1 with the base frame highlighted.

FIG. 19: is a plan view of a base frame of the embodiment of FIG. 1.

FIG. 20: is a side view of the embodiment of FIG. 1 with the articulated frame highlighted.

FIG. 21: is a plan view of the articulated frame of the embodiment of FIG. 1.

FIG. 22: is a side elevation and end elevation of a bed chair according to the embodiment of FIG. 1 shown in a folded configuration for transport.

FIGS. 23 & 24: illustrate a bed chair according to the embodiment of FIG. 1, including an arm rest.

FIGS. 25 & 26: show a side elevation of a bed chair according to the embodiment of FIG. 1, including a cot side rail.

FIGS. 27 to 29: illustrate side embodiments in various configurations of an alternative embodiment of a bed chair according to the present invention.

FIG. 30: illustrates diagrammatic side elevations of the embodiment of FIG. 1 in use.

FIGS. 31 & 32: illustrate diagrammatic side elevations of prior art bed chairs in use.

FIGS. 33 & 34: illustrate side elevations of a bed chair, including a leg lifter.

FIG. 35: illustrates a side elevation of a bed chair, including the leg lifter of FIGS. 33 and 34 in greater detail, with the leg rest removed.

FIG. 36: illustrates diagrammatically part of the leg lifter of the preceding Figures with the leg rest removed.

FIG. 37: illustrates a prior art leg lifter with the leg rest removed.

FIG. 38: is a side elevation of a further embodiment of a bed chair according to the present invention.

FIGS. 39 to 45: illustrate various folding arrangements of the embodiment of FIG. 38.

FIGS. 46 to 49: illustrate a side elevation, front elevation, rear elevation and plan view respectively of the embodiment of FIG. 38.

FIGS. 50 to 53: illustrate isometric views of a further embodiment of the invention in which movable side walls are provided.

FIGS. 54 & 55: illustrate isometric views of yet a further embodiment in which a flexible cover is provided over a part of the frame.

FIG. 56: is a side view of another embodiment with an alternative lifting mechanism.

FIG. 57: is a side view of embodiment shown in FIG. 56 in a raised position.

FIG. 58: is a side view of the embodiment shown in FIG. 56 in a chair configuration, with the chair tilted backward.

FIG. 59: is a side view of another alternative embodiment

FIG. 60: is a bottom view of the embodiment shown in FIG. 59 with the foot rest folded down

FIG. 61: is a side view of the embodiment shown in FIG. 59 with the foot rest folded down.

FIG. 62: is a bottom view of the embodiment shown in FIG. 59 in a bed configuration.

FIG. 63: is a side view of the embodiment shown in FIG. 59 in a bed configuration.

FIG. 64: is a side view of a further embodiment in a chair configuration, with the mattress removed for clarity.

FIG. 65: is a side view of the embodiment of FIG. 64 in an intermediate configuration.

FIG. 66: is a side view of the embodiment of FIG. 65 in a bed configuration.

FIG. 67: is a side view of a pivoting platform apparatus according to the present invention, with one leg of the base frame omitted for clarity.

FIG. 68: is a plan view of the pivoting platform of FIG. 67 with the base frame omitted.

FIG. 69: is a plan view of the pivoting platform of FIG. 67 connected to a bed chair according to FIG. 63, with the platform in a rotated position.

FIG. 70: is a plan view of the pivoting platform of FIG. 69, with the platform rotated to allow a user to lower themselves onto a bed or alight from the bed.

FIG. 71: is a side view of another embodiment of the pivoting platform, with a support member pivotally connected to the platform.

FIG. 71A: is a side view of the support member of the platform shown in FIG. 71, pivoting away from the platform.

FIG. 72: is a side view of a further embodiment of the pivoting platform with an articulated support member.

FIG. 73: is a side view of an alternative embodiment of a mattress in a chair configuration.

FIG. 74: is a side view of the mattress of FIG. 73 in a bed configuration.

### BEST MODES FOR PERFORMING THE INVENTION

In one embodiment a bed chair is provided having a bed mattress with an integrated and supporting base mechanism which can be shaped either with powered actuators or by manual adjustment between a bed configuration and a chair configuration, to assist a user with moving from sitting to lying and sitting to standing.

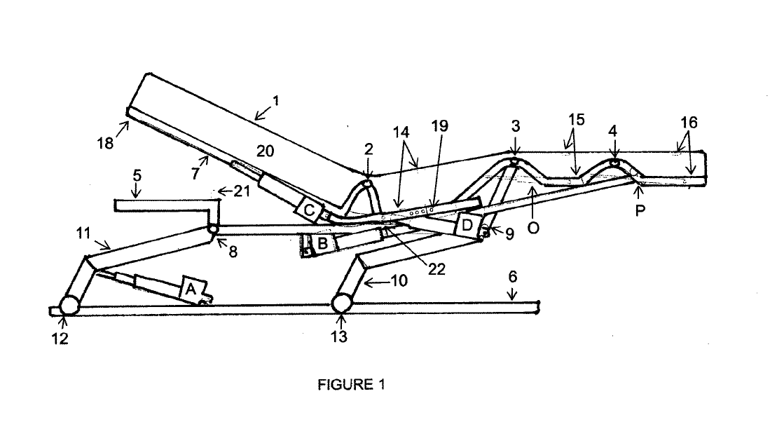

Referring to FIG. 1, a bed chair is shown in side elevation having a base frame 6 which supports a mattress 20 mounted on or about an articulated frame 7.

The mattress 20 is provided in a range of mattress qualities, including single and or multi-layered polyurethane foam with or without profile shaping of the surface, also memory foam or latex rubber. Thus the user has a choice of comfort and or pressure care. In one embodiment the mattress is covered with breathable elastic waterproof material, preferably polyurethane or PVC, such as that sold under the trade mark CARRFLEX.

The mattress 20 has an upper surface that provides a user support surface comprising a number of sections. Section 1 is a back rest section, section 14 is a seat section, section 15 is a lower leg rest section and section 16 is a foot rest section. The articulated frame 7 may be moved either manually or through the use of powered actuators (as will be described further below) to move the user support sections relative to each other to provide a bed configuration or a chair configuration and/or other configurations that may be required by the user.

In the embodiment illustrated in FIG. 1, the articulated frame 7 is disposed inside the mattress, adjacent to the perimeter. Those skilled in the art will appreciate that the mattress may be attached to the frame 7 using other arrangements. The articulated frame 7 is constructed of steel in the embodiment shown and includes a number of sections that are pivotally connected to each other at pivot connections 2, 3 and 4. In a conventional profiling bed arrangement the pivot connections would be located below the mattress. However, in the embodiment shown in FIG. 1, the pivot connections are located at least above the lower level of the mattress, and preferably adjacent to the upper surface of the mattress that supports the user. We have found that this arrangement in which the pivot connections are provided nearer to the upper surface of the mattress means the upper surface of the mattress does not creep as articulated frame 7 moves in use. This is helpful, particularly where the foot section of the leg rest area folds under the seat section, as will be described further below. The mattress and the frame 7 need to stay in the same plane in order to have the foot section fold under tightly. For the user, less mattress surface creep means less shear forces on the skin, providing better pressure care.

In some embodiments (not shown) the back rest section 1, seat section 14, lower leg rest section 15 and foot rest section 16 may all be separate foam mattress sections. These sections may then be overlaid with a continuous layer of softer foam, which may be easier to bend in order to accommodate the changes in shape of the bed chair. This improves the flexibility of the mattress, particularly around the foot rest and leg support portions, and reduces the tendency for the back rest section of mattress to be pulled away from the frame when the foot rest and leg support sections are folded, thereby allowing the user to sit back into the chair.

An elastic material may be provided to span the gaps between the separate mattress sections, providing support for the soft foam layer, while remaining flexible enough to be bent into the different positions required. The mattress cover may also be provided with connecting means, such as a zip, which allows the top part of the cover to be removed from the bottom half, thereby facilitating replacement of the mattress.

In one embodiment the mattress 20 is secured to the articulated frame 7 by gluing a 6 mm board to the lower surface of the mattress and bolting through this to the frame 7 at the seat section 14 the lower leg rest 15 and the foot rest 16. The mattress 20 can be additionally be secured to the board with thread and buttons. In the embodiment illustrated the back rest 1 is allowed to slip up and down and is secured to the frame 7 by a pocket 18 sewn into the mattress cover, which pocket is slipped over the top of the frame 7. This allows for independent movement of both the mattress and the frame.

The seat section 14 of the mattress is supported by section 19 of the frame 7 which includes overlapping frame sections that are secured to each other by fixing bolts. The depth of the seat section can be adjusted by adjusting frame parts in section 19 relative to each and relocating the fixing bolts as required.

The back rest section 1 can be adjusted in angle by the extension or retraction of actuator C which is mounted at one end to the back rest and the other end to the seat section of frame 7. The mounting points of actuator C may be manually adjustable in order to vary the angle of the back rest section 1 relative to the seat section 14 when the actuator C is fully extended.

The seat section 14 can be adjusted in angle by the extension or retraction of actuator D which is mounted at one end to the seat section 14, the other end to a middle frame 5 which is located between the base frame 6 and the articulated frame 7.

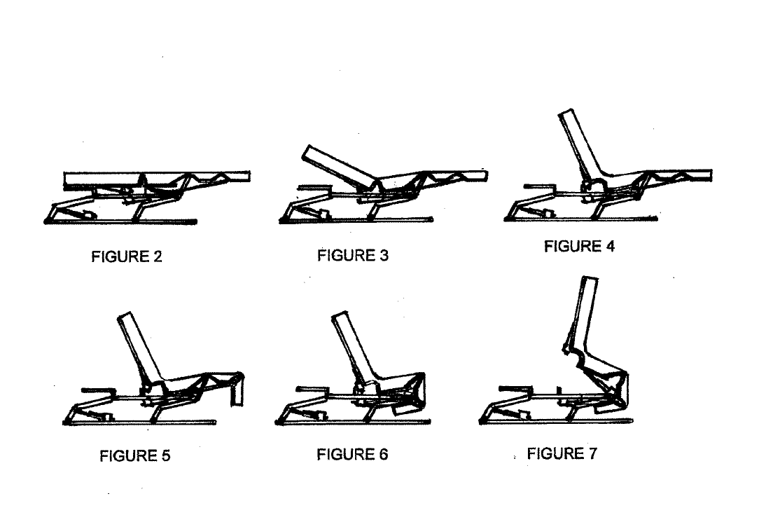

The leg rest sections comprising lower leg section 15 and foot rest section 16 can be adjusted in angle by the extension or retraction of actuator B which is mounted at one end to the middle frame 5 and the other end to the foot rest 16. A gas strut 0 is mounted to the seat section at one end and the lower leg rest at the other end. Gas strut P is mounted to the lower leg rest at one end and the foot rest at the other end. Both struts 0 and P assist with folding the foot rest tightly under the mattress when actuator B contracts, so that the foot rest section can be disposed under the seat section. This movement is shown in sequence with reference to FIGS. 2, 3 and 4.

The raising and lowering of the height of mattress 20 is achieved by the extension or retraction of actuator A. Lift arm 11 is pivotally connected at one end to the base frame 6 at point 12 and is pivotally connected at the other end to the middle frame 5 at point 8. Lift arm 10 is pivotally connected at one end to the base frame 6 at point 13 and is pivotally connected at the other end to the middle frame 5 at point 9. When actuator A extends or contracts, it pushes or pulls on lift arm 11 which causes the arm to rotate upward or downward and therefore raises or lowers the middle frame parallel to the floor. Optionally both lift arms 10 and 11 can be powered independently and linked to the middle frame 5 with single or double pivot connections.

Optionally, one lift arm could rotate up and the other rotate down causing the middle frame 5 to tilt forward or backward.

In a preferred embodiment the actuators connect to a transformer/control box and then to either a battery pack and or the mains power. A handset connects to the control box and buttons on the handset control all the actuators independently. Optionally, a synchronised action can be programmed in software so that a simple user selection on the handset can cause a preferred action, for example: pushing one button of the handset can cause the leg rest to extend and the back rest to lower at the same time therefore eliminating the need for the user to determine which sequence or combination of buttons to push to cause the desired action.

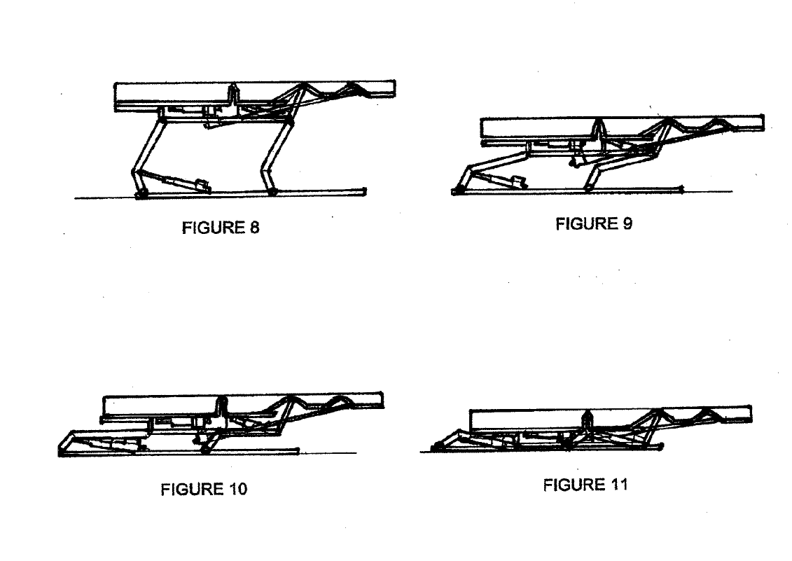

FIGS. 2 to 7 show the basic bed to chair actions that the bed chair can perform. FIG. 2 is the lay flat configuration used for sleeping. FIG. 3 shows the lay flat with knee break up. This shape provides a bottom well in the seat position and helps prevent the user slipping forward as the back rest raises. The knee break elevates the user's legs. FIG. 4 shows the back rest up with the legs out. FIG. 5 shows the lower leg rest and foot rest section partially folded. FIG. 6 shows the foot rest section folded under the seat section. In FIG. 7 the seat section is raised to assist the user with standing. All of these functions when operated in sequence can assist the user in moving from lying horizontally, to sitting, to standing. Reversing the sequence assists with moving from a standing to a sitting position, and then to a lying position.

FIGS. 8 to 11 show how the bed chair can be used as a high/low bed. The ability to provide a low position is often required in rest home environments as a safe configuration to limit injury should a user fall from the bed. The higher positions can be useful for the caregiver as the patient is disposed at a comfortable level for the caregiver to perform tasks without stooping. The high/low action can also be helpful to raise and lower the seat height when in the configuration shown in FIGS. 6 and 7 to suit tall or short people when attempting to sit or stand.

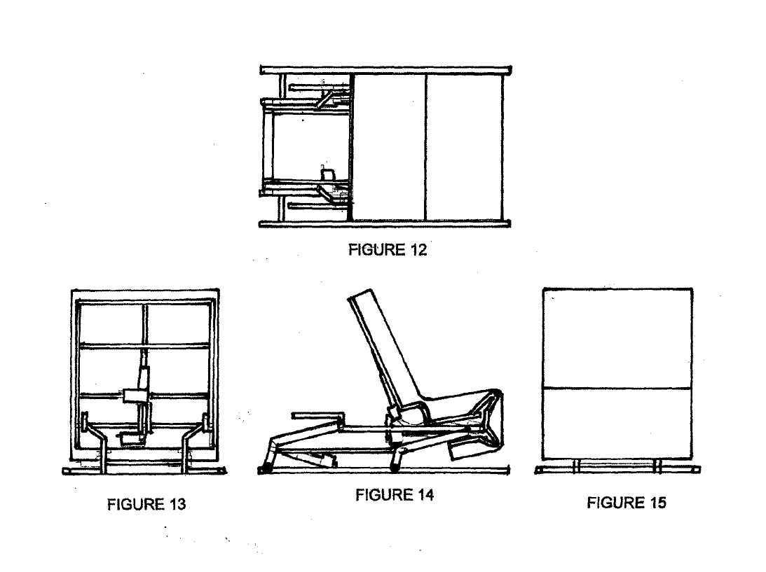

FIGS. 12 to 15 show a side view, top view, rear view and front view respectively of the bed chair.

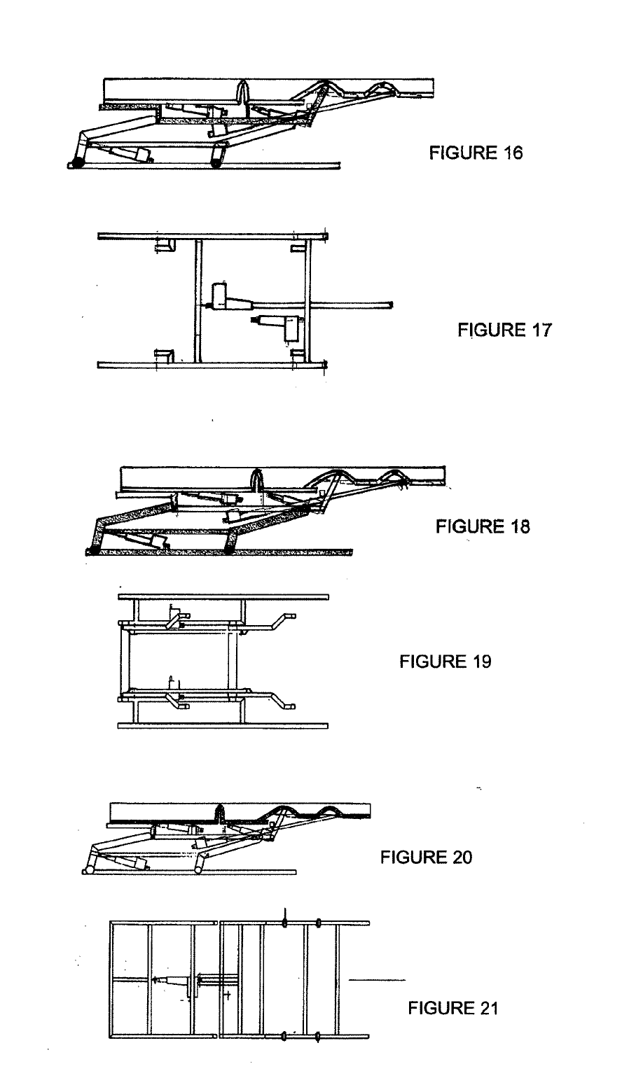

Furthermore, FIGS. 16, 18 and 20 show side views of the bed chair in the lie flat configuration, and in each of those figures one of the frame parts is identified and showed in top view in FIGS. 17, 19 and 21. Therefore, in FIGS. 16 the middle frame 5 is identified and the middle frame is shown in top view FIG. 17. In FIG. 18 the base frame is identified and the base frame is shown in top view in FIG. 19. In FIG. 20 the articulated frame 7 is shown in side view and is then in top view in FIG. 21.

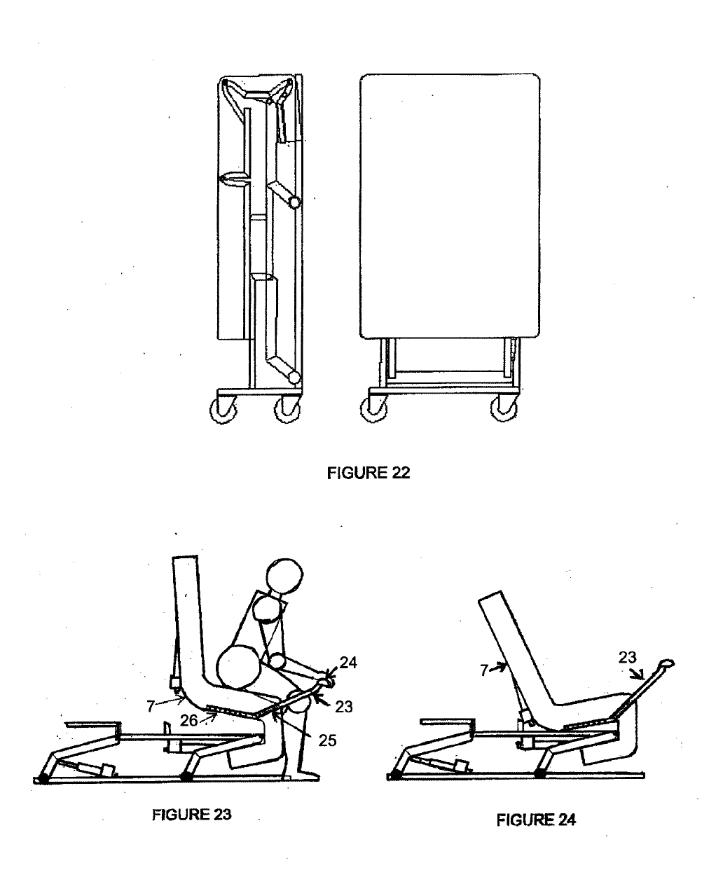

As shown in FIG. 22, in one embodiment wheels may be provided and the bed chair may fold so as to be easily transportable.

Turning to FIGS. 23 and 24, a handrail 23 can be optionally fitted to the frame 7 and extends forward to a desired position. The handrail can be adjusted at points 25 and 26 to obtain a position best suited to assist the user to stand up from the sitting position as shown,

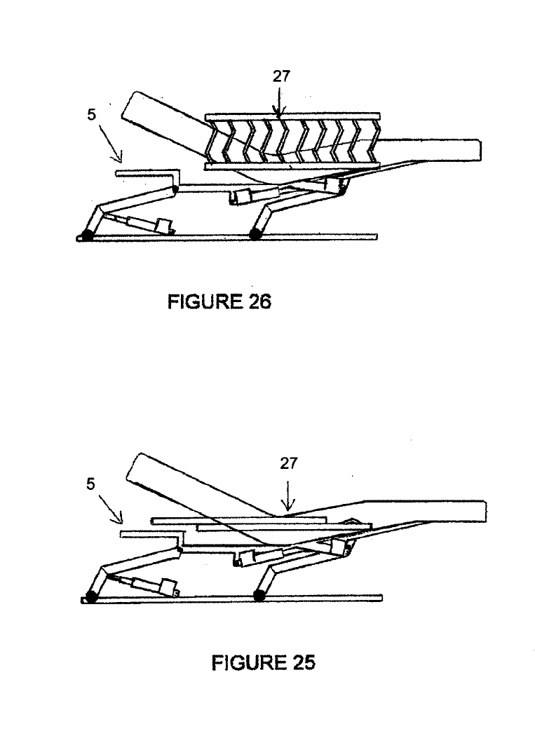

Referring next to FIGS. 25 and 26, optionally, cot side rails 27 can be fitted to either side of the bed chair and clamp or fix to the middle frame 5. The cot side rail can fold down as in FIG. 25 and unfold upward as in FIG. 26. Cot side rails are used to prevent the user rolling off the bed.

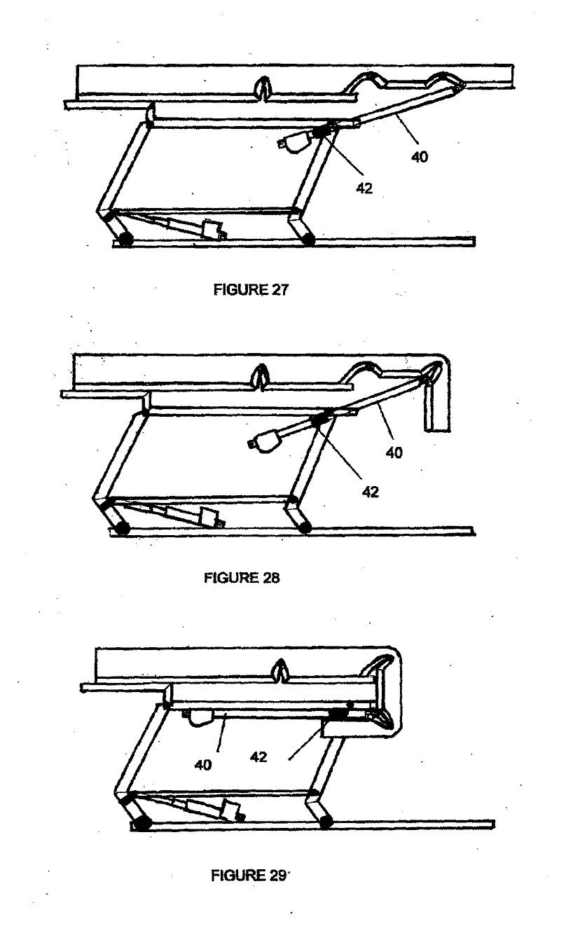

Referring now to FIGS. 27 to 29, a further embodiment of the invention is shown which is essentially the same as that described with reference to FIG. 1, the exception that actuator B is replaced by a cantilevered actuator which is referenced 40. Actuator 40 has an actuator carriage 41 which is pivotally mounted to the middle frame or base frame. When the foot rest is folded under the seat portion, a significant portion of the actuator is cantilevered and unsupported, as shown in FIG. 29. This causes an upward force on the actuator mounting where the mounting is connected to the footrest. This upward force is helpful for ensuring that the footrest folds tightly under the seat portion, so that the seat section, the lower leg section and the foot rest section together fold tightly into a U-shape. The range of movement through which the actuator moves from the lie flat position to the fully folded position is shown sequentially in FIGS. 27 to 29.

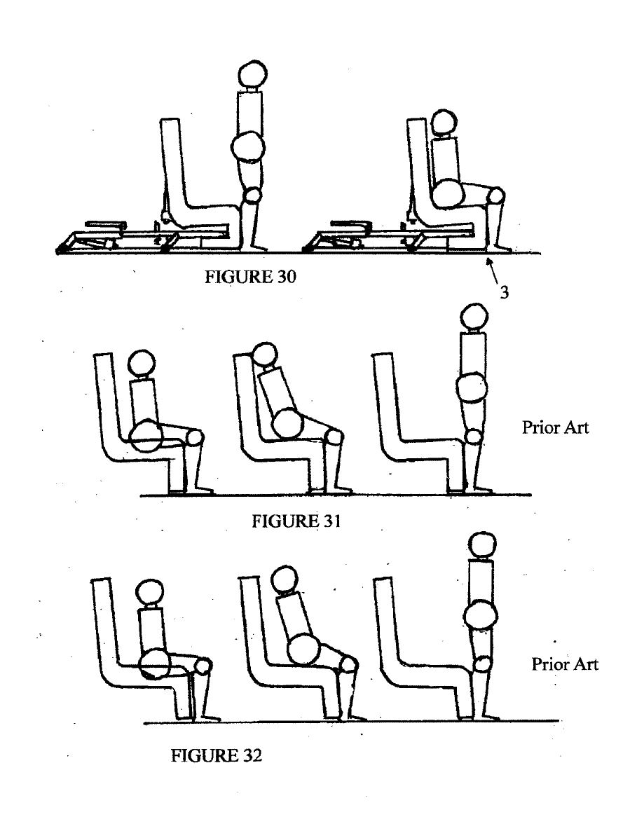

A bed chair as described above is shown diagrammatically together with a user in outline in FIG. 30 to enable a comparison to be made with two prior art products which are illustrated in FIGS. 31 and 32. As can be seen, the prior art products are not very comfortable, nor ergonomically correct. The human model is measured correctly from an average height fit female 1680 mm tall. This accords with most users of a bed chair product who are frequently female, elderly and somewhat stooped.

The prior art products have a seat height which is too high, even at the lowest height, and a seat depth which is too deep. The leg rest 9 does not become vertical either and this hinders the user when they are trying to get seated far enough back on the seat. This is in contrast to the embodiment of the present invention shown in FIG. 30. Because the seat depth is adjustable it can be customised to maximise utility and comfort. The seat height can go as low as 300 mm. As this is lower than most people will need, upward adjustment can be stopped at any point so the most appropriate seat height can be obtained. There is also room for the user to get his or her feet back as far as possible. This helps with standing as the body weight of the user needs to be over the feet before standing. The further forward the feet are the further forward the user needs to move before standing and this increases the effort required to stand.

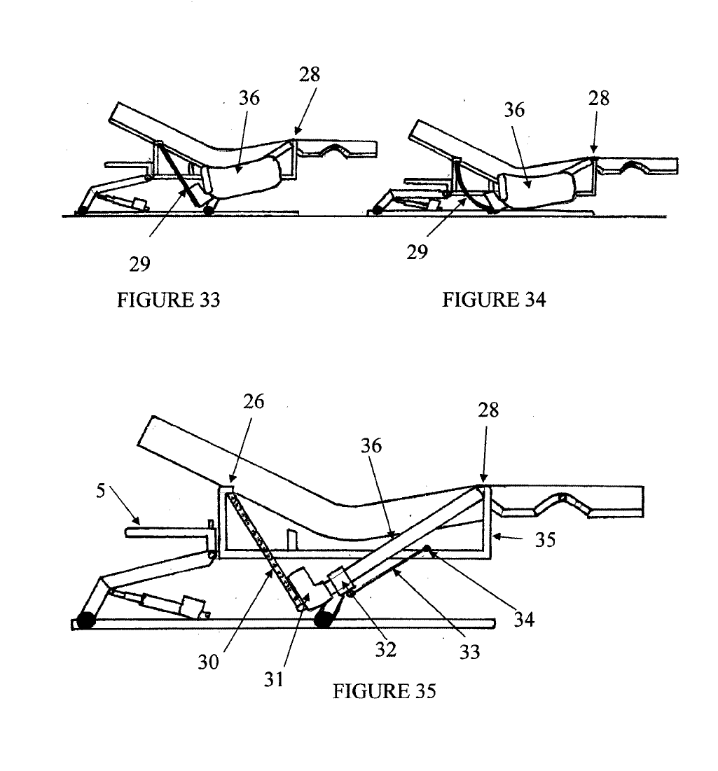

In another embodiment, a leg lifter 36 can be added to either side of the bed as an integrated part, or a removable attachment. Further background on leg lifter operation and construction is described in our International Patent Publication No. WO 2008075982, the disclosure of which is incorporated herein by reference. When the bed chair is made to lower to such an extent that the leg lifter touches the floor, then a flexible lift arm such as chain lift arm 29 simply flexes and rod end bearing/pivot point 28 allows the leg lifter to rotate upward, as in FIGS. 33 and 34. Thus the flexible arm provides stability in one plane, but flexes in the other. Those skilled in the art will appreciate that the flexible arm may be implemented in ways other than using a chain. For example, an arm with one or more pivot points could be used.

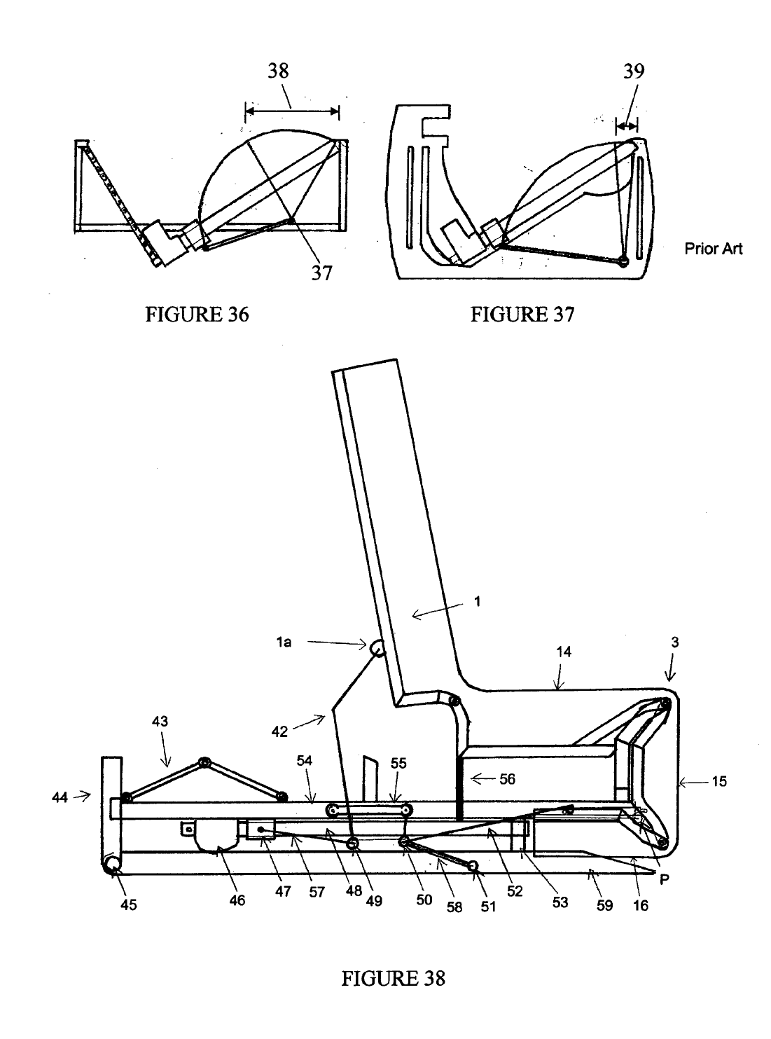

As shown in FIGS. 35 and 36, the leg lifter frame 35 bolts to the bedside and a telescopic rod 33 is in a location in which it is pivotally connected 37 to the frame at a point above the lowermost part of the frame. The pivotal connection 37 to the frame is also spaced inwardly from the end of the frame. This pivot location creates a desirable flat arc 38 at the top of the stroke of rod 33 and therefore the leg rest spends a much longer time parallel with the mattress top surface. This facilitates retracting the leg rest from under the user's legs before the leg rest needs to turn vertical to lower beside the bed. The prior art pivot location 37A and arc of movement 38A are shown in FIG. 37.

Turning to FIG. 38, another embodiment is shown. Unlike the previous embodiment in which an actuator may be dedicated to each movement function, this embodiment has a single actuator which enables a number of different configurations. The actuator moves an arrangement of link rods to maneuver the mattress through the basic required configurations systematically from bed to chair then back to the bed shape. In some embodiments actuation may be manual. The bed chair of this embodiment may accommodate all of the attachments and integrated parts described in the previous embodiment.

The mattress and articulated frame are essentially the same as that described above with reference to the previous embodiment, and connect to a new middle frame at point 3. The new middle frame has one or two central frame members 54 which are also heavy duty sliding tracks. Within the track 54 is a sliding carriage 55 which is powered back and forward by an electronic actuator 46 or chain. The carriage or driving end of the actuator 47 is connected to the sliding carriage 55 through link rod 57. As the sliding carriage 55 moves forward the link bar 42 rotates downward and the back rest lowers. The sliding carriage 55 is also connected to the foot rest through link bar 52. As the actuator carriage 47 moves forward the foot rest and lower leg rest unfold. The sliding carriage 55 is also connected to the lift rod 58. As the actuator carriage moves forward the lift rod 58 rotates upward, lifting the seat of the mattress and the middle frame which is hinged at point 45to the base foot frame 59. This lifting action of the rotating lift arm 58 provides clearance between the foot rest and the floor for the foot rest to unfold.

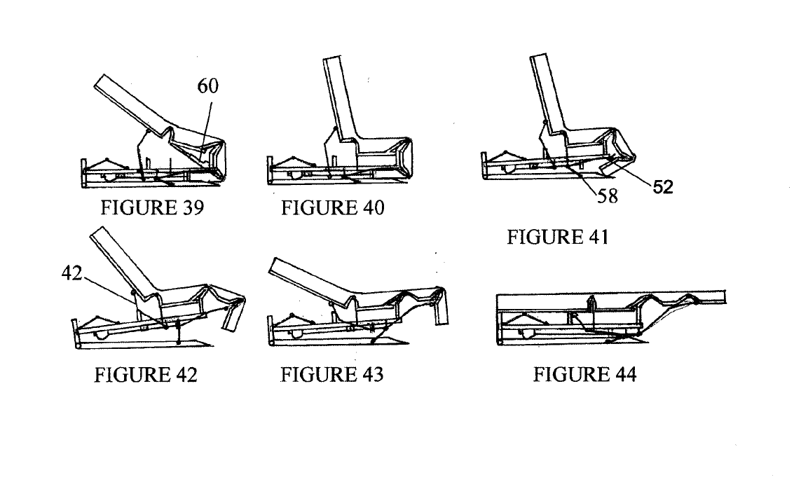

The change in configuration is illustrated sequentially with reference to FIGS. 39 to 44 which show the actuator 46 pushing the actuator carriage 47 and sliding carriage 55 forward from left to right to cause the sequence of seated position through to the horizontal lying position. The reverse action can then be caused by reversing the direction of the actuator.

FIG. 39 shows use of an optional actuator 60 which can be used to raise the seat section to assist the user to stand, but which is not required for moving the bed chair between sitting and lying configurations. FIG. 40 shows the seated position, and in FIG. 41 the seat section begins to tilt backward and rise as link rod 58 rotates upward, and the leg rest begins to unfold as the link bar 52 pushes forward. In FIG. 42 the back rest begins to lower as the link bar 42 rotates downward, and in FIG. 43 the mattress begins to lower as the link bar 58 rotates downward. Finally, as shown in FIG. 44, the actuator reaches the end of its stroke as does the carriage within the sliding door track which causes the mattress to come to rest in the lie flat horizontal position.

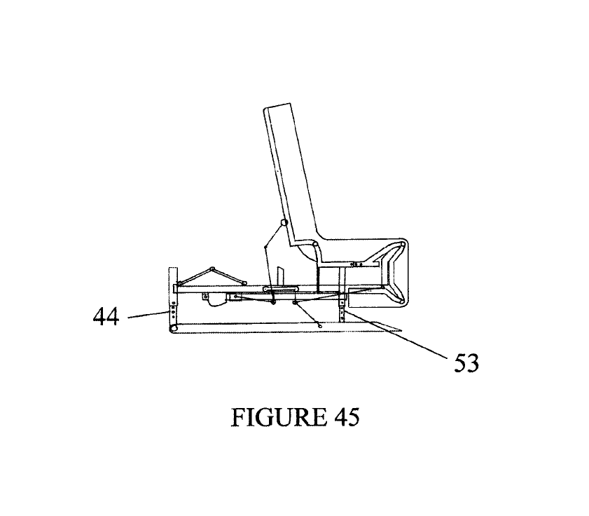

In other embodiments the adjustable back rest support 43 is hinged at two points and fixed at the third. This allows the adjustable support to have a higher or lower apex therefore providing alternative slope angles for the final resting place of the back rest. Also, adjustable seat tilt support 56 can be adjusted up or down to predetermine the seat angle. Furthermore, vertical legs 44 and 53 can be adjusted up or down to give a predetermined seat height as indicated in FIG. 45.

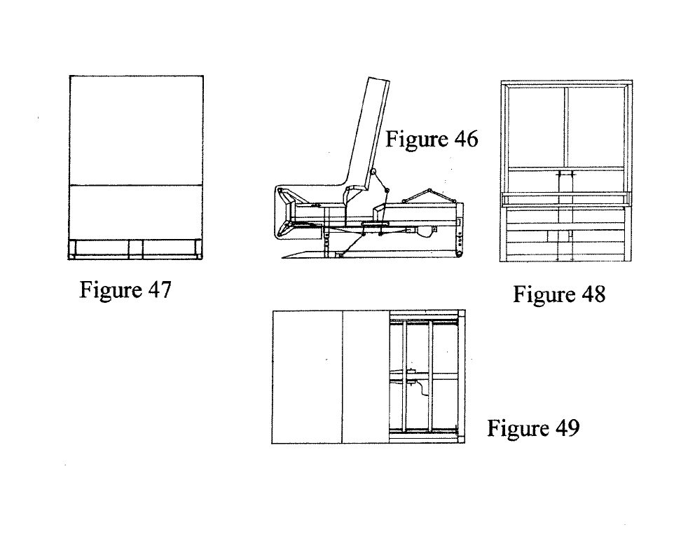

Referring now to FIGS. 46 to 49, the embodiment as described with reference to FIGS. 38 to 44 is shown in side elevation from the other side, and a front view, rear view and top view are shown in FIGS. 47, 48 and 49 respectively.

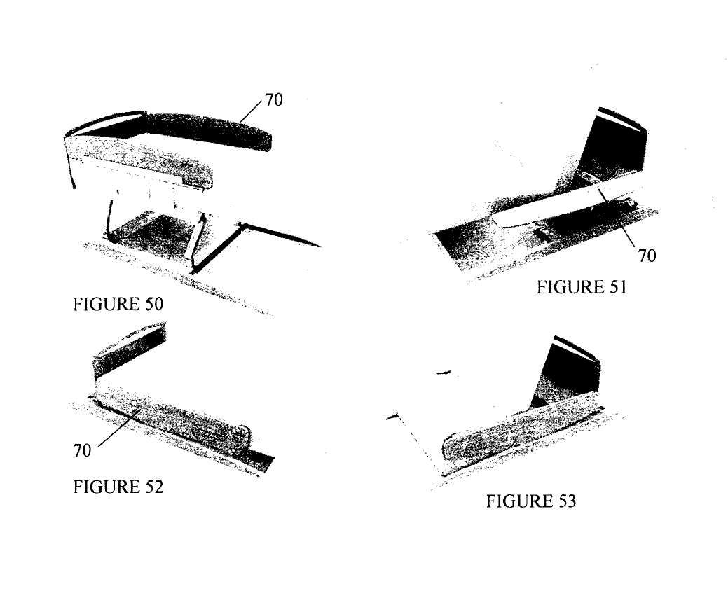

In FIGS. 50 to 53, another embodiment is shown in which side walls 70 are provided. Side walls 70 are pivotally and/or slideably connected to a part of the frame so that they may be disposed to function as cot walls (as shown in FIG. 50), or function as a side board or table (as shown in FIG. 51), or be located out of the way alongside the mattress (as shown in FIGS. 52 and 53). In this way they can be moved so as to be above, level with, or below the upper surface of the mattress. In particular, they may be slid directly from a cot wall orientation of FIG. 50 to the orientation shown in FIG. 52 by a simple downward sliding movement.

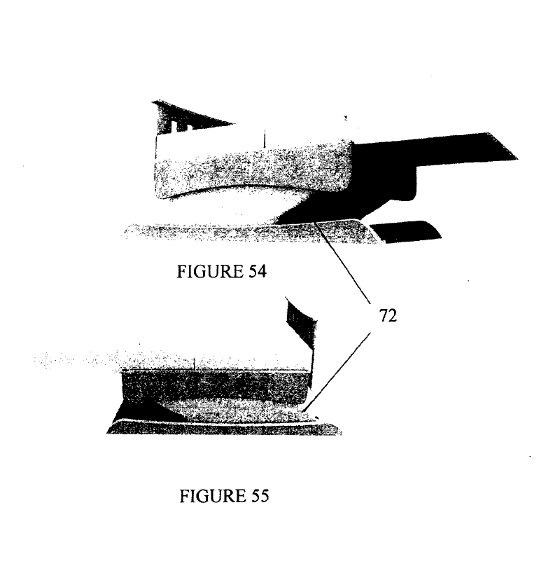

In FIGS. 54 and 55, yet another embodiment is shown in which frame parts between the base and the mattress that would normally be exposed are covered with a flexible cover or boot 72. This can prevent unwanted entanglement in frame parts, and improve aesthetics of the apparatus.

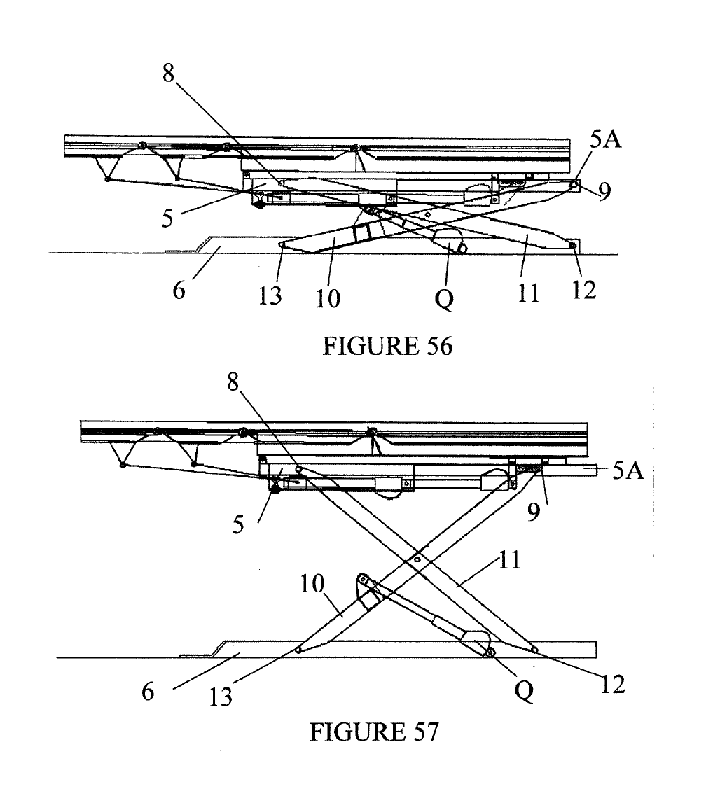

Referring next to FIGS. 56 and 57, a further embodiment is shown. In this embodiment the lift arms 10, 11 are arranged in a scissor lift configuration. The lift arms 10, 11 are pivotally connected to the base frame 6 at points 12 and 13, but the connection at point 12 is arranged to be slideable in a direction which is substantially parallel to the longitudinal axis of the base 6 (and the ground). An actuator Q is provided between the base frame 6 and the lift arm 10 to provide the motive force for moving the middle frame 5 up or down.

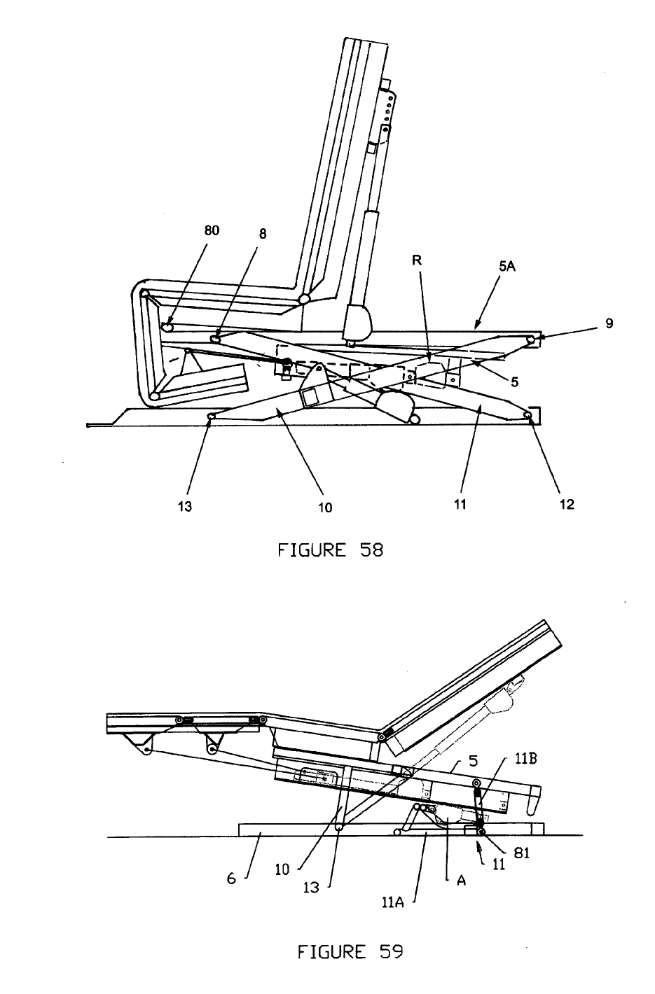

As is best seen with reference to FIGS. 56, 57 and FIG. 58, in this embodiment the middle frame 5 is not connected directly to the lift arms 10, 11. Rather, the middle frame 5 is pivotally connected to a support frame 5A at pivot point 80, which is towards the front of the middle frame 5.

Lift arm 11 has a pivotal connection to support frame 5A at point 8 and lift arm 10 has a pivotal connection to support frame 5A at point 9. As is best illustrated by reference to FIGS. 56 and 57, the connection at point 9 is also configured to be slideable along the longitudinal axis of the support frame 5A.

Pivotally mounting the middle frame 5 to support frame 5A allows the inclination of the back rest, seat, leg rest and foot rest sections to be altered simultaneously by an actuator (not shown), and independently of the height of the bed chair.

Referring next to FIG. 59, in another embodiment lift arm 10 may be rigidly connected to and/or integral with middle frame 5, and may have a pivotal connection directly to the base frame 6. Lift arm 11 may be divided into a first arm segment 11A and a second arm segment 11B, with a pivotal connection 81 between the arm segments 11A, 11B. Actuator A may be used to rotate arm segment 11A relative to base frame 6, thereby adjusting the angle of middle frame 5 and the bed.

In the embodiment shown in FIG. 59 the height of the bed may be adjusted manually by changing the vertical position of the connection point 13.

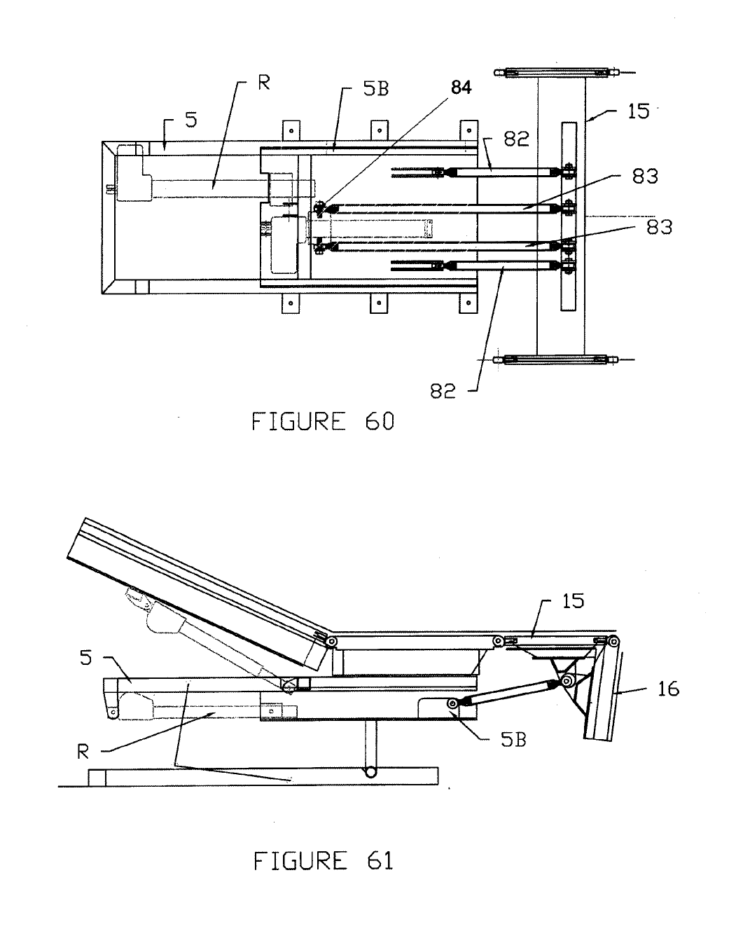

Referring next to FIGS. 60 to 63, in the embodiment shown a different mechanism is used to change configuration between bed and chair. In this embodiment the sliding carriage is configured as a subframe 5B which is slideably connected to the middle frame 5. An actuator R is provided between the middle frame 5 and subframe 5B to control the position of the subframe 5B relative to the middle frame 5.

Connecting rods 82 connect the subframe 5B to the lower leg rest section 15, so that movement of the subframe 5B relative to middle frame 5 will raise or lower the lower leg rest section 15.

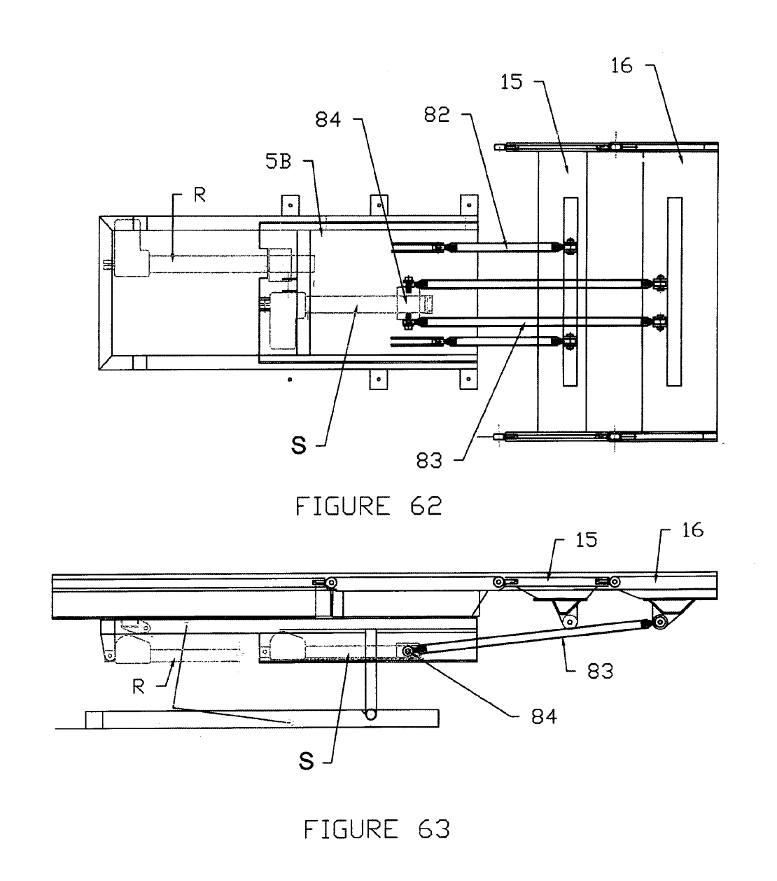

Connecting rods 83 are provided between the footrest section 16 and a mounting point 84. The mounting point 84 is movable relative to the subframe 5B. In a preferred embodiment the mounting point 84 is slideable relative to the subframe 5B under the action of an actuator S, as is best seen with reference to FIGS. 62 and 63. In this way the angle of the footrest section 16 relative to the lower leg rest section 15 can be changed.

This mechanism may be used with any of the embodiments shown in FIGS. 56-59.

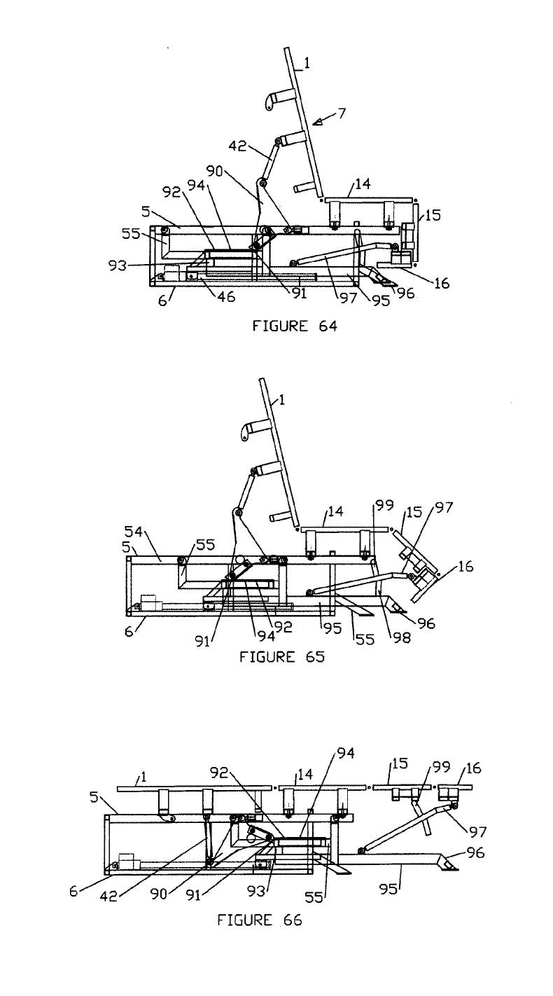

Referring next to FIGS. 64 to 66, an alternative embodiment of the bed chair shown in FIGS. 38 to 44 is shown. In the description of this embodiment, reference to the back rest 1, seat section 14, lower leg rest section 15 and foot rest section 16 are to be read to include reference to the respective sections of the articulated frame 7 corresponding to those sections.

In the embodiment shown in FIGS. 64-66 the sliding carriage 55 is configured as a subframe. The sliding carriage 55 can be moved longitudinally back and forth relative to the base frame 6 by the actuator 46. The actuator may be of any suitable type, for example telescopic (not shown).

The link bar 42 is not directly connected to the sliding carriage 55, but instead is pivotally connected to a rocker arm mechanism 90 which is pivotally connected to the middle frame 5. In this embodiment the seat section 14 is connected to the middle frame 5 and does not move relative to the middle frame 5. In the embodiment shown the middle frame 5 is rigidly connected to the base frame 6.

The rocker arm is provided with a follower portion 91 which bears against guide means 92 which is connected to or integral with the sliding carriage 55. The guide means 92 includes a substantially vertical portion 93 and a substantially horizontal portion 94.

The sliding carriage 55 is also provided with a leg portion 95 which extends substantially horizontally towards the foot of the bed, the distal end of the leg portion 95 being provided with a foot portion 96.

A link bar 97 is pivotally connected to the leg portion 95 at a first end and to the foot rest section 16 at an opposite end.

As can be seen in FIG. 64, when the bed chair is to be in a chair configuration, the actuator 46 moves the sliding carriage 55 towards the head end of the bed. With the sliding carriage 55 in this position the follower portion 91 is in contact with the horizontal portion 94 of the guide means 92. This holds the rocker arm 90 in a position which causes the back rest 1 to be in a substantially upright position, suitable for use in a chair configuration.

FIG. 65 shows the bed in an intermediate position. In this position the sliding carriage 55 is approximately midway between its extreme positions. In this position the link bar 97 has begun to unfold the foot rest section 16. The link bar 97 is provided with a downwardly extending stop 98 which bears against the top of the leg portion 95 to hold the link bar 97 substantially the same angular position during this phase of the movement.

In the intermediate position shown in FIG. 65 the follower portion 91 is still bearing against the horizontal portion 94 of the guide means 92, and so the back section 1 remains in substantially the same position as in FIG. 62.

Referring next to FIG. 66, it can be seen that the bed chair has moved to a bed configuration. Movement of the sliding carriage 55 to a position towards the foot end of the bed has caused the follower portion 91 to slide off the horizontal portion 94 of the guide means 92 and down the vertical portion 93. This in turn has allowed the rocker arm 90 to rotate and the back section 1 to be lowered to a substantially horizontal orientation. This movement occurs relatively quickly, since the relatively small movement of the carriage 55 between the position shown in FIG. 65 and the position shown in FIG. 66 allows the rocker arm 90 to rotate through approximately 90°. In other embodiments (not shown), the substantially vertical portion of the guide means may be angled so as to act as a “ramp”.

At the same time the link bar 97 has moved the foot section 16 to a substantially horizontal position. The link bar 97 is also provided with an upwardly extending support 98 which supports the lower leg rest section 15 when in this position.

It can also be seen that the foot portion 96 has been moved to maintain its position under the foot rest section 16, thereby providing additional stability and decreasing the chance of the bed tipping or moving if a person sits or leans on the foot of the bed.

Those skilled in the art will appreciate that the embodiment provided in FIGS. 64-66 requires only one actuator, but is still able move between a chair configuration, an intermediate configuration and a bed configuration. The use of a single actuator may not only make the embodiment cheaper to manufacture, but also has the advantage that the different configurations can be achieved using a controller which has only two buttons. The bedchairs of the prior art which use multiple actuators typically either require the user to activate the different actuators manually to reconfigure the bedchair, or else have electronic controllers to activate the actuators, which can be unreliable.

Of course, if required the back section 1 may be adjusted by a separate actuator and the rocker arm 90 and guide means 92 omitted, although this may be at the expense of some of the advantages mentioned above.

Those skilled in the art will also appreciate that the rails from which the sliding carriage 55 is suspended may be provided in any suitable orientation and/or vertical location. For example, in one embodiment the rails may be provided adjacent the base 6 frame.

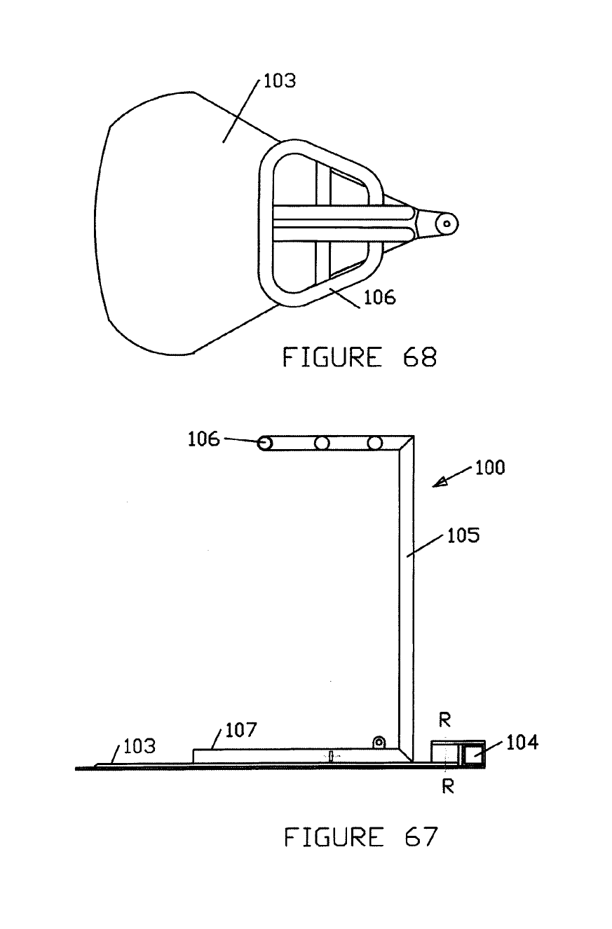

Referring next to FIGS. 67 to 70, the bed chair of FIGS. 64 to 66 is provided with an optional pivoting platform apparatus, generally referenced 100.

The apparatus 100 has a base frame 101 which, in the embodiment shown, is connectable to or integral with a base frame of the bed chair. The base frame 101 is preferably substantially “L” shaped, and the connection with the bed chair is provided at an extreme end of a first leg 102 of the L.

A platform 103 is rotatably connected to the second leg 104 of the frame 100, so as to be rotatable about a substantially vertical axis R-R. A substantially vertical support member 105 is connected to the platform 103. In a preferred embodiment the vertical support member 105 is close to or collinear with the axis R-R.

A handrail means 106 is provided at the top of the support member 105.

In the embodiment shown the platform 103 is connected to a platform frame 107.

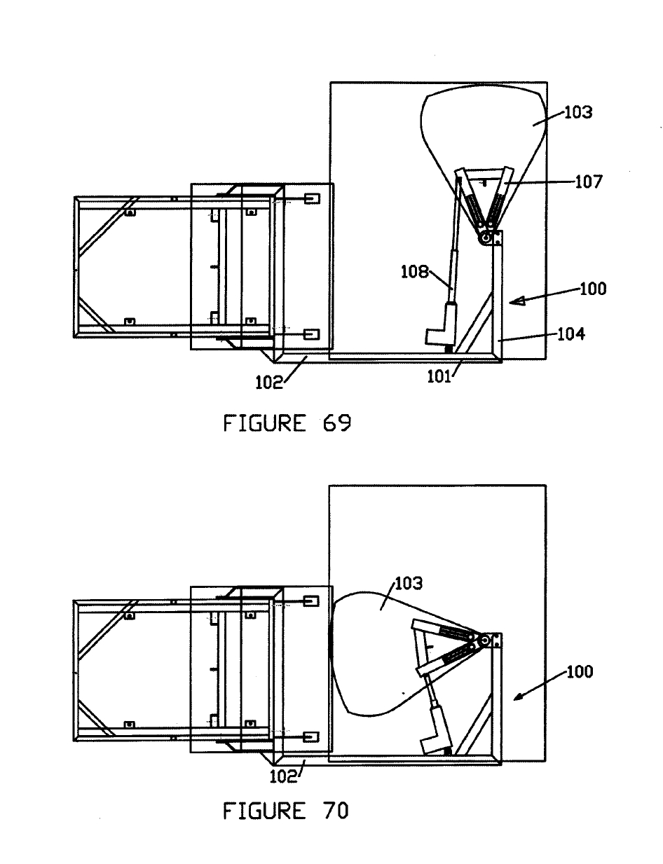

The apparatus 100 is used as follows. To assist a user to sit on the bed chair, an actuator 108, which is provided between the base frame 101 and the platform 103 and/or platform frame 107, extends in order to rotate the platform 103 to a position which is approximately 90° to the longitudinal axis of the bed chair, as is shown in FIG. 69. The user then stands on the platform 103 and holds the hand rail 106. The actuator 108 is activated and retracts, rotating the platform about the rotational axis R-R until the platform is facing the bed chair, as shown in FIG. 70. In preferred embodiments the platform rotates through between 90° and 110°, most preferably 110°. From this rotated position the user can lower themselves onto the bed, using the hand rail 106 for assistance if necessary.

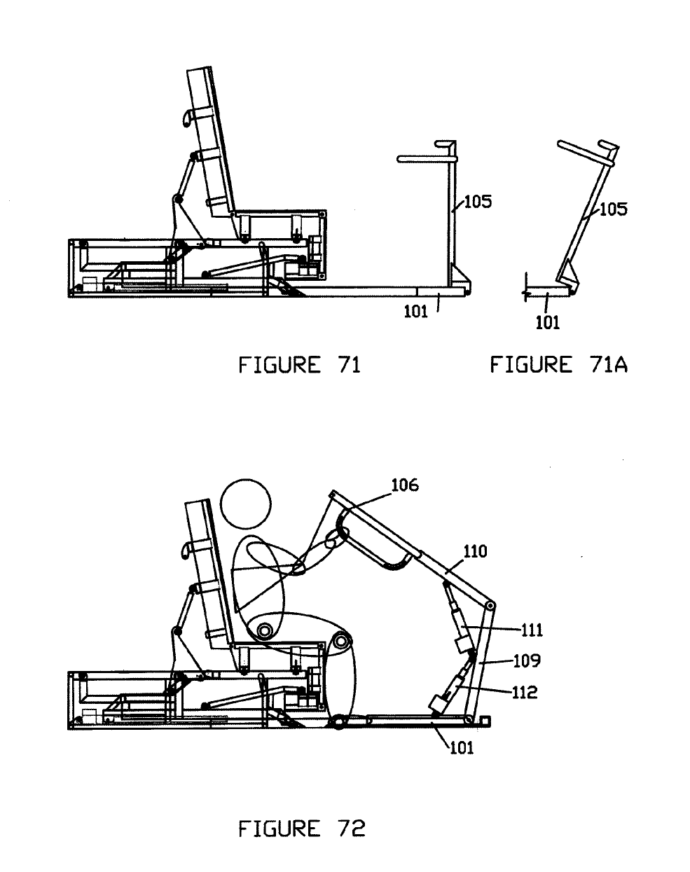

Referring next to FIGS. 71 and 71A, in one embodiment the support member 105 may be rotatably connected to the base frame 101 or platform, so as to allow the support member 105 to rotate away from the base frame 101 about a substantially horizontal axis of rotation. The support member 105 may be biased towards the substantially vertical position shown in FIG. 71. However, the support member 105 may be pushed away from the platform, as shown in FIG. 71A, if necessary. The support member 105 is preferably not rotatable beyond a substantially vertical position when pulled in the opposite direction.

Referring next to FIG. 72, in another embodiment the support member 105 may comprise a lower support member 109 which is connected to the base frame 101 or platform, and an upper support member 110 which is rotatably connected to the distal end of the lower support member 109. An actuator 111 is provided between the lower support member 109 and upper support member 110. This allows the hand rail 106 to be raised and lowered, thereby assisting a user to alight from the bed and/or lower themselves onto the bed.

In the preferred embodiment shown in FIG. 72 the lower member 109 may be rotatably connected to the base frame 101 or platform and an actuator 112 may be provided between the base frame 101 or platform and the lower member 109. By actuating both actuators 111, 112 together, the movement of the hand rail 106 can be controlled to provide more of a vertical lifting movement than a pure arc. The embodiments shown in FIGS. 71, 71A and 72 may also be modified by omitting the pivoting platform, the pivoting/articulated support members 105 being useful when connected directly to a base frame.

In some embodiments a body sling may be used with the apparatus 100 to assist the user with standing up or sitting down onto the bed.

In some embodiments the apparatus 100 may be releasably connectable to the bed chair, and may be provided with a set of wheels to allow the apparatus to be moved between bed chairs.

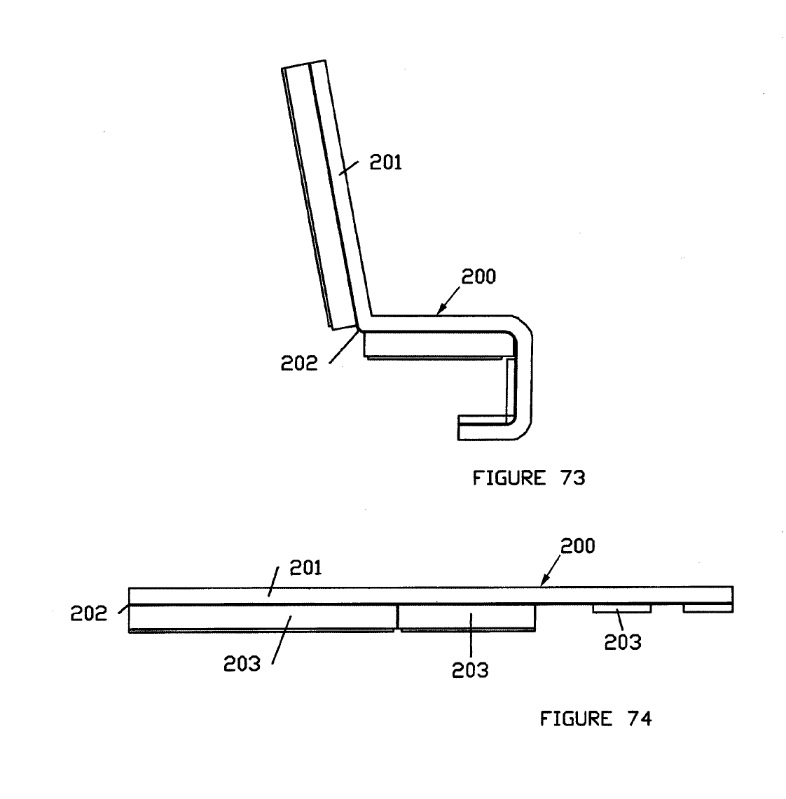

Referring next to FIGS. 73 and 74, an alternative embodiment of a mattress for use with the bed chair apparatus described above is generally referenced by arrow 200. The mattress 200 has a substantially continuous upper layer of foam 201 which is connected to a sheet of elastic material 202. Individual sections of foam 203 are provided on the lower side of the elastic material 202, and correspond to the back rest, seat section, lower leg rest section and foot rest section, although the sections 203 corresponding to the lower leg rest section and foot rest section are spaced apart to provide the mattress 200 with the required flexibility.

The elastic layer 202 supports the top layer of foam 201 when the mattress 200 is in the bed configuration shown in FIG. 74, but allows the top layer of foam 201 to be sufficiently thin to fold into the chair configuration shown in FIG. 74.

Pleats may be provided in the mattress cover to allow the cover to bend when the back rest is elevated.

Those skilled in the art will appreciate that the present invention provides apparatus that have a number of advantages, including:

A leg rest or foot rest that folds under the seat. This feature ensures that when the leg rest or foot rest is unfolded into the lie flat position that there is enough length of leg rest to support the feet of the user.

The compact design and low positioning of the actuators and levers means that in some embodiments the mattress can go as low as 170 mm to the base frame and 300 mm overall to the top of the mattress when in the chair profile and also when in the bed profile. In some embodiments the average maximum height overall to the top of the mattress is 900 mm. This compares with known profiling beds which typically have a variance between minimum and maximum height of 400-500 mm. The present invention has a variance of 600 mm in some embodiments.

Manual or powered actuation is possible, and in some embodiments a single actuator may be used to convert the apparatus between the bed and chair-like configurations.

A seat panel is provided which can be manually adjusted in depth to enable the seat pan to be deeper or shallower to suit the user.

In some embodiments the apparatus can be provided as a standard profiling bed without the fold under function of the leg or foot rest. The benefit to the user is that this provides a powered bed that will go very low. In this configuration a leg lifter which includes a flexible support arm as described above can be optionally added to the side of the bed if required.

The embodiments described are easily strengthened by thickening the wall size of the steel frame and adding additional actuators or upgrading the actuator motor size to suit the needs of overweight users.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the appended claims.

1-25. (canceled)

26. A bed chair apparatus including a user support surface which includes a back section, a seat section, a lower leg section and a foot section that are configured to articulate relative to each other, whereby the user support surface is configurable in a bed configuration in which the support surface is substantially flat and in a chair configuration in which the foot section is disposed beneath the seat section.

27. A bed chair apparatus as claimed in claim 26 wherein the support surface comprises a mattress which is provided on a support frame, the support frame having pivotal connections between adjacent sections of the support surface to enable the sections to articulate relative to each other, the pivotal connection between the foot section and the lower leg section being nearer to an upper surface of the mattress than a lower surface of the mattress.

28. A bed chair apparatus as claimed in claim 27 wherein the pivotal connection between the seat section and the lower leg section is nearer to the upper surface of the mattress than the lower surface of the mattress.

29. A bed chair apparatus as claimed in claim 27 wherein the upper surface is substantially continuous.

30. A bed chair apparatus as claimed in claim 26 wherein the seat section can be adjusted to provide clearance between the foot section and a floor surface during articulation.

31. A bed chair apparatus as claimed in claim 26 wherein the seat section can be adjusted to raise the seat section in the chair configuration to facilitate entry or exit of a user.

32. A bed chair apparatus as claimed in claim 30 wherein the seat section can be adjusted in angle or height.

33. A bed chair apparatus as claimed in claim 26 comprising a base frame and a middle frame, wherein the user support surface is dependent from the middle frame and a lift arm is provided between the middle frame and the base frame to tilt the middle frame relative to the base frame.

34. A bed chair apparatus as claimed in claim 33 wherein the lift arm raises or lowers the middle frame.

35. A bed chair apparatus as claimed in claim 26 wherein the depth of the seat section is adjustable.

36. The bed chair apparatus of claim 26 comprising a base frame, a middle frame and an adjustable carriage.

37. The bed chair apparatus of claim 36 wherein the adjustable carriage is movable longitudinally relative to the middle frame.

38. The bed chair apparatus of claim 37 wherein a single actuation means moves the carriage, and link members are provided between the carriage and the back section and between the carriage and the foot section such that the apparatus is articulated between the bed configuration and the chair configuration by the single actuation means.

39. The bed chair apparatus of claim 36 wherein the adjustable carriage is provided with guide means and the link member between the adjustable carriage and the back section comprises a rocker arm having follower means which bear against the guide means.

40. The bed chair apparatus of claim 36 wherein the adjustable carriage is provided with a leg portion and a foot portion, and wherein the foot portion is located substantially beneath the foot section when the bed chair is in the bed configuration.

41. The bed chair apparatus of claim 40 wherein when the apparatus is in the bed configuration the location of the foot portion prevents the apparatus from overbalancing.

42. The bed chair apparatus of claim 26 wherein the support surface comprises a mattress which is provided on a support surface frame, the support surface frame having pivotal connections between adjacent sections of the support surface to enable the sections to articulate relative to each other.

43. The bed chair apparatus of claim 42 wherein the pivotal connections between sections of the support surface are closer to an upper surface of the mattress than to a lower surface of the mattress.

44. The bed chair apparatus of claim 43 wherein the upper surface of the mattress is substantially continuous.

45. The bed chair apparatus of claim 26 wherein the foot section is substantially parallel to a floor surface when the apparatus is disposed in the chair configuration.

46. The bed chair apparatus of claim 26 wherein the apparatus can be manually moved between the chair and bed configurations.
